(19) United States
(12) Patent Application Publication
(10) Pub. No.: US 2026/0145431 A1
(43) Pub. Date: May 28, 2026

(54) LIQUID DISCHARGE HEAD, HEAD UNIT, AND LIQUID DISCHARGE APPARATUS

(71) Applicant: Masaya SHINGYOH, Kanagawa (JP)

(72) Inventor: Masaya SHINGYOH, Kanagawa (JP)

(21) Appl. No.: 19/351,341

(22) Filed: Oct. 7, 2025

(30) Foreign Application Priority Data
Nov. 27, 2024 (JP) 2024-206433

(51) Int. Cl. B41J 2/14; B41J 3/54; B41J 15/04; B41J 25/00; B41J 29/377

(52) U.S. Cl. CPC B41J 2/1433; B41J 3/543; B41J 15/04; B41J 25/005; B41J 29/377

(57) ABSTRACT

A liquid discharge head includes a nozzle plate and a connection channel. The nozzle plate has a nozzle, an inlet port, and an outlet port. The nozzle is disposed on a nozzle face of the nozzle plate to discharge a liquid from the nozzle onto an object in a discharge direction. The inlet port is disposed on the nozzle face of the nozzle plate. The inlet port is disposed upstream from the nozzle in an airflow direction orthogonal to the discharge direction. The outlet port is disposed on the nozzle face of the nozzle plate. The outlet port is disposed downstream from the nozzle in the airflow direction. The connection channel connects the inlet port and the outlet port in the airflow direction to form a ventilation passage.

### CROSS-REFERENCE TO RELATED APPLICATION

This patent application is based on and claims priority pursuant to 35 U.S.C. § 119(a) to Japanese Patent Application No. 2024-206433, filed on Nov. 27, 2024, in the Japan Patent Office, the entire disclosure of which is hereby incorporated by reference herein.

### BACKGROUND

### Technical Field

The present disclosure relates to a liquid discharge head, a head unit, and a liquid discharge apparatus.

### Related Art

An inkjet image forming apparatus as a liquid discharge apparatus discharges liquid (ink) to a moving object that moves relative to the inkjet image forming apparatus to form an image. For example, the moving object is a sheet such as paper being conveyed. Typically, the inkjet image forming apparatus includes a liquid discharge head having multiple nozzles for discharging liquid (ink).

### SUMMARY

The present disclosure described herein provides an improved liquid discharge head including a nozzle plate and a connection channel. The nozzle plate has a nozzle, an inlet port, and an outlet port. The nozzle is disposed on a nozzle face of the nozzle plate to discharge a liquid from the nozzle onto an object in a discharge direction. The inlet port is disposed on the nozzle face of the nozzle plate. The inlet port is disposed upstream from the nozzle in an airflow direction orthogonal to the discharge direction. The outlet port is disposed on the nozzle face of the nozzle plate. The outlet port is disposed downstream from the nozzle in the airflow direction. The connection channel connects the inlet port and the outlet port in the airflow direction to form a ventilation passage.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall configuration of an inkjet image forming apparatus as a liquid discharge apparatus;

FIG. 2 is a block diagram illustrating a control system of an image forming apparatus;

FIG. 3 is a plan view of a head unit;

FIG. 4 is a side view of a liquid discharge head as viewed in a horizontal direction;

FIG. 5 is a plan view of a liquid discharge head as viewed from a nozzle face side;

FIG. 6 is a cross-sectional view of the liquid discharge head of FIG. 5 taken along line A-A in FIG. 5;

FIG. 7 is a cross-sectional view of the liquid discharge head of FIG. 5 taken along line B-B in FIG. 5;

FIG. 8 is a plan view of a nozzle plate, a first channel plate, and a second channel plate superimposed one on another;

FIG. 9 is another plan view of a nozzle plate, a first channel plate, and a second channel plate superimposed one on another;

FIG. 10 is yet another plan view of a nozzle plate, a first channel plate, and a second channel plate superimposed one on another;

FIG. 11 is a plan view of a serial type head unit;

FIG. 12 is a side view of a liquid discharge head mounted on a serial type head unit;

FIG. 13 is a diagram illustrating an airflow when a liquid discharge head moves in one direction;

FIG. 14 is a diagram illustrating an airflow when a liquid discharge head moves in an opposite direction;

FIG. 15 is a schematic diagram illustrating an overall configuration of an electrode manufacturing apparatus; and

FIG. 16 is a side view of a liquid discharge head according to a comparative example as viewed in a horizontal direction.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings for illustrating embodiments of the present disclosure, like reference signs are assigned to elements such as components and parts that have a like function or a like shape as far as distinguishable, and descriptions of such elements may be omitted once the description is provided.

### Overall Configuration of Image Forming Apparatus

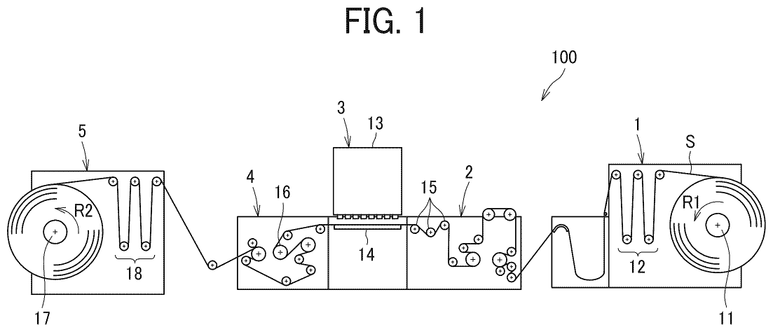

FIG. 1 is a schematic diagram illustrating an overall configuration of an inkjet image forming apparatus as a liquid discharge apparatus. The overall configuration of the inkjet image forming apparatus will be described below with reference to FIG. 1.

As illustrated in FIG. 1, an image forming apparatus 100 includes a sheet supply device 1 that supplies a sheet S on which an image is to be formed, a conveyance device 2 that conveys the sheet S supplied from the sheet supply device 1, an image forming device 3 that forms an image on the sheet S, a drying device 4 that dries the sheet S, and a sheet collection device 5 that collects the sheet S on which the image has been formed.

The sheet supply device 1 includes a supply roller 11 and a tension adjustment mechanism 12. The sheet S is a long, continuous sheet wound in a roll around the supply roller 11. The tension adjustment mechanism 12 adjusts tension to be applied to the sheet S. The supply roller 11 is rotatable in the direction indicated by arrow R1 illustrated in FIG. 1, and the sheet S is fed from the supply roller 11 as the supply roller 11 rotates. The tension adjustment mechanism 12 includes multiple adjustment rollers that apply tension to the sheet S stretched over the multiple adjustment rollers. The tension of the sheet S is adjusted by changing the interval between the adjustment rollers, and the sheet S is supplied with a constant tension.

The conveyance device 2 is provided with multiple conveyance rollers 15 as a conveyor that conveys the sheet S. When the sheet S is supplied from the sheet supply device 1 to the conveyance device 2, the sheet S is conveyed to the image forming device 3 by the multiple conveyance rollers 15.

The image forming device 3 includes a head unit 13 and a platen 14. The head unit 13 includes multiple liquid discharge heads that discharge ink (i.e., liquid) onto the sheet S. The platen 14 serves as a sheet support that supports the sheet S being conveyed. The sheet S conveyed by the conveyance rollers 15 passes below the head unit 13 while being supported by the platen 14. At this time, ink is discharged from the head unit 13 onto the sheet S to form an image on the sheet S.

The drying device 4 includes a heating drum 16 as a heater that heats the sheet S. The heating drum 16 is a cylindrical heater accommodating a heating source such as a halogen heater therein. When the sheet S on which an image has been formed in the image forming device 3 is conveyed to the drying device 4, the sheet S contacts the outer circumferential surface of the heating drum 16. As a result, the sheet S is heated and dried. In addition to a contact type heater such as the heating drum 16, a non-contact type heater such as a hot air generator that blows hot air onto the sheet S may also be used as the heater that heats the sheet S.

The sheet collection device 5 includes a collection roller 17 and a tension adjustment mechanism 18. The collection roller 17 winds and collects the sheet S. The tension adjustment mechanism 18 adjusts tension to be applied to the sheet S. The collection roller 17 is rotatable in the direction indicated by arrow R2 in FIG. 1, and the sheet S is wound into a roll shape and collected as the collection roller 17 rotates. The tension adjustment mechanism 18 includes multiple adjustment rollers, similar to the tension adjustment mechanism 12 of the sheet supply device 1. The tension of the sheet S is adjusted by changing the interval between the adjustment rollers, and the sheet S is wound and collected with a constant tension by the collection roller 17.

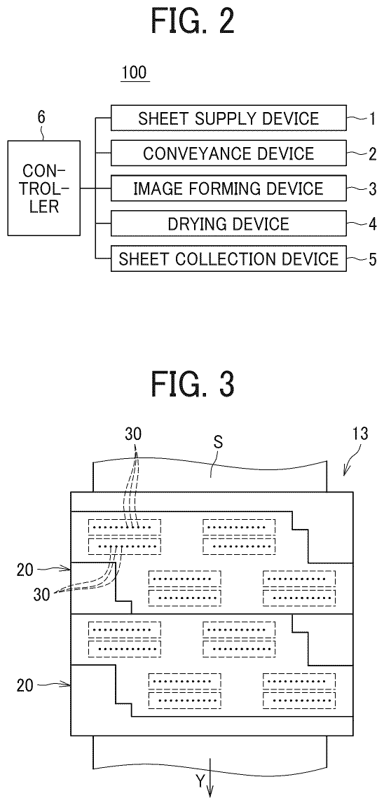

FIG. 2 is a block diagram illustrating a control system of an image forming apparatus. As illustrated in FIG. 2, the image forming apparatus 100 includes the sheet supply device 1, the conveyance device 2, the image forming device 3, the drying device 4, the sheet collection device 5, and a controller 6 that controls the sheet supply device 1, the conveyance device 2, the image forming device 3, the drying device 4, and the sheet collection device 5.

The controller 6 includes an information processor such as a personal computer (PC). The controller 6 generates image data of an image to be formed on the sheet S. In addition, the controller 6 controls various types of operation of the sheet supply device 1, the conveyance device 2, the image forming device 3, the drying device 4, and the sheet collection device 5. For example, the controller 6 controls an ink discharge operation of the head unit 13, the rotation speeds of the supply roller 11, the collection roller 17, and each conveyance roller 15, and the heating temperature of the heating drum 16. The head unit 13 discharges ink onto the sheet S based on image data generated by the controller 6 to form an image on the sheet S.

### Configuration of Head Unit

A configuration of the head unit 13 will be described below with reference to FIG. 3. FIG. 3 is a plan view of the head unit 13.

As illustrated in FIG. 3, the head unit 13 includes multiple liquid discharge heads 20. Each of the liquid discharge heads 20 has multiple nozzles 30 to discharge ink as liquid droplets. In this case, the multiple nozzles 30 are arrayed in a direction orthogonal to or intersecting a sheet conveyance direction Y (i.e., a moving direction) in which the sheet S is conveyed. The arrangement of the nozzles 30 is not limited to the arrangement of FIG. 3. The multiple nozzles 30 may be two-dimensionally arrayed in the moving direction and a width direction of the sheet S orthogonal to the moving direction.

In the present embodiment, a so-called line type head unit that discharges ink without moving relative to the sheet S is adopted as the head unit 13. In this case, when the sheet S is conveyed in the sheet conveyance direction Y in FIG. 3 and reaches a position (image forming position) facing the head unit 13, ink is discharged from the nozzles 30 of the head unit 13 to the sheet S being conveyed to form an image on the sheet S.

### Deviation of Landing Position of Liquid

The deviation of the landing position of liquid discharged from the liquid discharge head will be described below based on a comparison between the present embodiment and a comparative example different from the present embodiment. FIG. 16 is a side view of a liquid discharge head 200 according to the comparative example as viewed in the horizontal direction (direction orthogonal to a discharge direction of liquid).

The liquid discharge head 200 according to the comparative example is a line type liquid discharge head similarly to the liquid discharge head 20 according to the present embodiment. Accordingly, as illustrated in FIG. 16, when the sheet S is conveyed in the sheet conveyance direction Y and reaches a position facing the liquid discharge head 200, an ink 10 is discharged from multiple nozzles 201 to the sheet S being conveyed.

At this time, air around the nozzles 201 moves in the discharge direction of the ink 10 (liquid) along with the movement (dropping) of the ink 10 discharged as liquid droplets. As a result, the amount of air decreases between the adjacent nozzles 201 (a portion 90 surrounded by the alternate long and short dash line in FIG. 16) to form a negative pressure state in the portion 90. Then, air in the surroundings of the portion 90 moves to the portion 90 between the nozzles 201 (portion in the negative pressure state) to compensate for the reduced amount of air. Accordingly, an airflow 9A flowing from the surroundings toward a portion between the nozzles 201 is generated. When the discharged ink 10 is affected by the airflow 9A, the ink 10 curves as indicated by the dashed arrow in FIG. 16, and thus the landing position of the ink 10 is deviated.

The air moving toward the sheet S along with the movement of the discharged ink 10 collides with the sheet S facing the liquid discharge head 200, and an airflow 9B spreading along the sheet S is generated. The conveyance of the sheet S causes air in the surroundings of the sheet S to move to generate an airflow 9C directed in the sheet conveyance direction Y (i.e., an airflow direction orthogonal the discharge direction). Accordingly, particularly on the upstream side of the nozzles 201 in the sheet conveyance direction Y, the airflow 9C directed in the sheet conveyance direction Y and the airflow 9B directed in the direction (upstream side) opposite to the sheet conveyance direction Y collide with each other, and an upward airflow 9D directed from the sheet S toward the liquid discharge head 200 is generated. When the upward airflow 9D collides with a nozzle face 202 of the liquid discharge head 200, a part of the upward airflow 9D (i.e., an airflow 9E) is directed toward the nozzles 201 along the nozzle face 202. Accordingly, in particular, in the most upstream nozzle 201 in the sheet conveyance direction Y, the discharged ink 10 is affected by the airflow 9E directed toward the nozzles 201 and may curve in the direction indicated by the dashed arrow in FIG. 16. Accordingly, the deviation of the landing position may become more significant.

As described above, in the liquid discharge head 200 according to the comparative example, the deviation of the landing position of the ink 10 occurs due to the influence of the negative pressure generated along with the discharge of the ink 10 and the influence of the upward airflow 9D generated on the upstream side in the sheet conveyance direction Y.

In a certain comparative example, an atmosphere communication passage is open on the nozzle face side and the face side other than the nozzle face of the liquid discharge head to supply air to a portion where a negative pressure is likely to occur to reduce the deviation of the landing position due to the influence of the negative pressure. However, the deviation of the landing position due to the influence of the upward airflow caused by the conveyance of the sheet has not been considered.

An object of the present disclosure is to effectively reduce the deviation of the landing position due to the influence of the upward airflow as well as the deviation of the landing position due to the influence of the negative pressure. A liquid discharge head according to the present embodiment will be described below.

### Configuration of Liquid Discharge Head

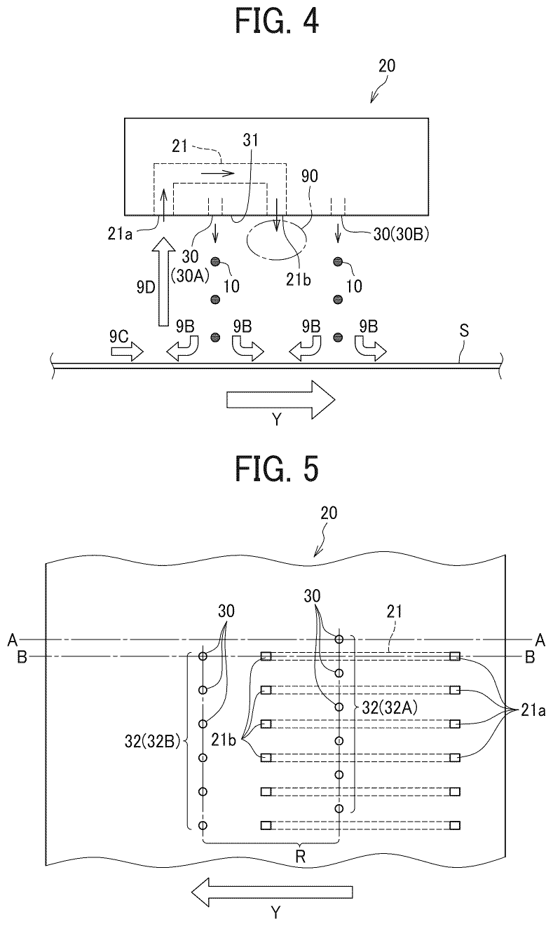

FIG. 4 is a side view of the liquid discharge head 20 according to the present embodiment as viewed in the horizontal direction (direction orthogonal to the discharge direction of liquid). The liquid discharge head 20 may be referred to simply as a head in the following description.

As illustrated in FIG. 4, the liquid discharge head 20 includes a ventilation passage 21 penetrating the inside of the liquid discharge head 20. Both ends of the ventilation passage 21 are openings (i.e., an inlet port 21a and an outlet port 21b) open to the outside from the liquid discharge head 20. The opening (inlet port 21a) functions as an “inlet port” through which air flows into the ventilation passage 21 from the outside. The opening (outlet port 21b) functions as an “outlet port” through which air flows out of the ventilation passage 21 to the outside. The inlet port 21a and the outlet port 21b both are open on a nozzle face 31 on which the nozzles 30 (i.e., a nozzle 30A and a nozzle 30B in FIG. 4) are open.

The inlet port 21a is arranged at a position corresponding to a portion of the upward airflow 9D generated on the upstream side in the sheet conveyance direction Y. In the present embodiment, as in the above-described comparative example, on the upstream side of a most upstream nozzle 30A in the sheet conveyance direction Y, the airflow 9C directed in the sheet conveyance direction Y (i.e., the airflow direction) and the airflow 9B directed in the direction (upstream side) opposite to the sheet conveyance direction Y collide with each other to generate the upward airflow 9D. For this reason, the inlet port 21a is disposed upstream from the most upstream nozzle 30A where the upward airflow 9D is generated. In FIG. 4, the airflow direction of the airflow 9C is directed along the moving direction of the sheet S orthogonal to the discharge direction. The ventilation passage 21 is disposed (extended) in the moving direction.

The outlet port 21b is arranged at a position corresponding to a portion (the portion 90 surrounded by the alternate long and short dash line in FIG. 4) where a negative pressure may be generated along with the discharge of the ink 10. Since the negative pressure is generated between the adjacent nozzles 30A and 30B, the outlet port 21b is arranged between the nozzle 30A and the nozzle 30B which are adjacent to each other in the sheet conveyance direction Y.

As described above, in the liquid discharge head 20, the inlet port 21a is arranged at the position corresponding to the portion where the upward airflow 9D is generated, and the outlet port 21b is arranged at the position corresponding to the portion where a negative pressure may be generated, to effectively reduce the deviation of the landing position due to the upward airflow and the negative pressure.

More specifically, as illustrated in FIG. 4, when the ink 10 is discharged from each of the nozzles 30A and 30B to the sheet S being conveyed, on the upstream side of the most upstream nozzle 30A, the airflow 9B generated along with the discharge of the ink 10 and the airflow 9C in the sheet conveyance direction Y generated along with the conveyance of the sheet S collide with each other to generate the upward airflow 9D. The upward airflow 9D is directed toward the liquid discharge head 20, and the inlet port 21a is disposed at a position to which the upward airflow 9D is directed, and thus, the upward airflow 9D flows into the liquid discharge head 20 through the inlet port 21a. Such a configuration prevents the upward airflow 9D from colliding with the nozzle face 31 to prevent the airflow (e.g., the airflow 9E directed toward the nozzles 201 in FIG. 16) generated by the upward airflow 9D that collides with the nozzle face 31. Accordingly, the discharged ink 10 can be prevented from curving under the influence of the airflow directed toward the nozzle 30A to reduce the deviation of the landing position.

As illustrated in FIG. 4, the upward airflow 9D that has flown into the ventilation passage 21 flows out of the ventilation passage 21 through the outlet port 21b. As a result, the portion (the portion 90 surrounded by the alternate long and short dash line in FIG. 4) where a negative pressure may be generated between the adjacent nozzles 30A and 30B is replenished with air. Accordingly, since the generation of the negative pressure is prevented, the deviation of the landing position of the ink 10 due to the generation of the negative pressure is reduced.

As described above, in the present embodiment, in addition to the deviation of the landing position due to the influence of the negative pressure, the deviation of the landing position due to the influence of the upward airflow is also effectively reduced, and thus, the landing accuracy of the ink is enhanced. As a result, a high-quality image can be formed. In the present embodiment, both the influence of the upward airflow and the influence of the negative pressure can be effectively prevented simply by the ventilation passage 21 formed in the liquid discharge head 20, and thus, the landing accuracy can be enhanced with the simple configuration of the ventilation passage 21 of the liquid discharge head 20.

A description will be given below of a more specific configuration of the liquid discharge head 20. FIG. 5 is a plan view of the liquid discharge head 20 as viewed from the nozzle face 31 side.

As illustrated in FIG. 5, the liquid discharge head 20 includes multiple nozzle arrays 32 (two nozzle arrays 32A and 32B in FIG. 5), in each of which multiple nozzles 30 are arrayed in a direction orthogonal to the sheet conveyance direction Y. The nozzles 30 of the nozzle array 32A and the nozzles 30 of the nozzle array 32B are shifted from each other in the direction (top-and-bottom direction in FIG. 5) orthogonal to the sheet conveyance direction Y. The number of the nozzle arrays 32 and the arrangement of the nozzles 30 are not limited to the example of FIG. 5, and can be changed as appropriate.

In the liquid discharge head 20, multiple inlet ports 21a and multiple outlet ports 21b are respectively arranged in a nozzle array direction of the nozzles 30 (top-and-bottom direction in FIG. 5) of the nozzle array 32. The multiple inlet ports 21a are disposed upstream from the most upstream nozzle 30 (the nozzle array 32A) in the sheet conveyance direction Y. The multiple outlet ports 21b are disposed between the nozzles 30 (the nozzle arrays 32A and 32B) which are adjacent to each other in the sheet conveyance direction Y. The phrase “between the nozzles 30” as used herein does not necessarily mean a position on a line segment connecting the adjacent nozzles 30. The phrase “between the nozzles 30” refers to any position within a range R downstream from the upstream nozzles 30 and upstream from the downstream nozzles 30 in the sheet conveyance direction Y. In other words, the multiple outlet ports 21b are disposed between the upstream nozzles 30 of the nozzle array 32A and the downstream nozzles 30 of the nozzle array 32B, which are adjacent to each other in the sheet conveyance direction Y.

Specifically, in the example of FIG. 5, each of the outlet ports 21b is not disposed on the line segment connecting the adjacent nozzles 30, and is disposed upstream from the downstream nozzles 30 in the sheet conveyance direction Y.

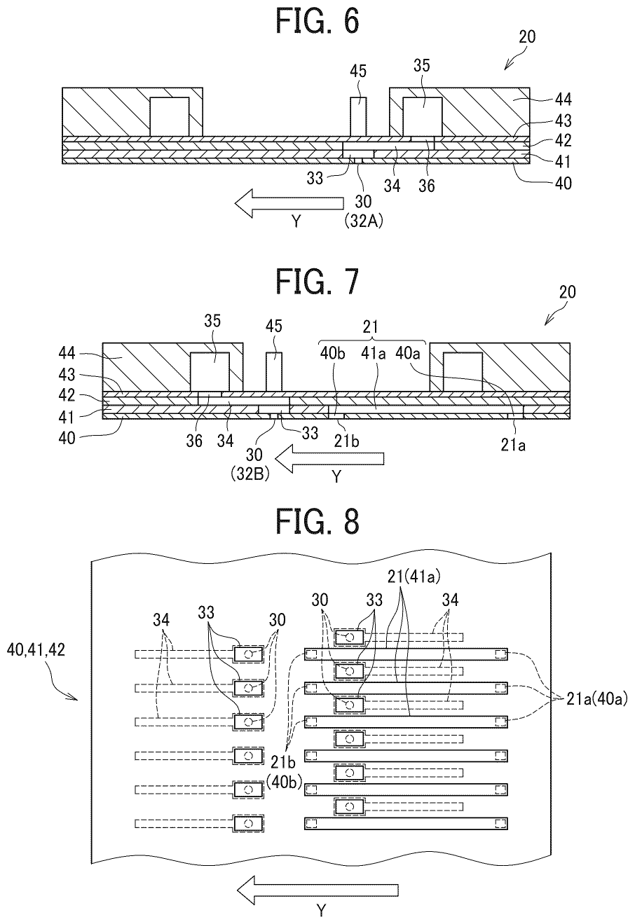

FIG. 6 is a cross-sectional view of the liquid discharge head 20 taken along line A-A in FIG. 5. As illustrated in FIG. 6, the liquid discharge head 20 includes a nozzle plate 40 having the nozzles 30, a first channel plate 41, a second channel plate 42, a diaphragm 43, a common channel substrate 44, and a piezoelectric element 45. The nozzle plate 40, the first channel plate 41, the second channel plate 42, the diaphragm 43, and the common channel substrate 44 are laminated in this order from the sheet side (bottom side in FIG. 6).

The first channel plate 41 has multiple pressure chambers 33 that individually communicate with the multiple nozzles 30. The second channel plate 42 has multiple individual supply channels 34 that individually communicate with the multiple pressure chambers 33.

The diaphragm 43 includes a deformable sheet. The piezoelectric element 45 is disposed at a portion of the diaphragm 43 corresponding to the pressure chamber 33. The piezoelectric element 45 is, for example, a component formed by alternately laminating a piezoelectric layer and an internal electrode, and a wiring board is connected to the internal electrode via an external electrode. When a drive voltage is applied to the piezoelectric element 45 via the wiring board, the piezoelectric element 45 expands and contracts to deform the diaphragm 43 and pressurize the liquid (ink) in the pressure chamber 33 so as to discharge the liquid from the nozzles 30.

The common channel substrate 44 has a common supply channel 35 communicating with all of the multiple individual supply channels 34. When liquid is supplied to the common supply channel 35, the liquid is supplied to each of the individual supply channels 34 via a supply port 36 formed in the diaphragm 43, and is further supplied from each of the individual supply channels 34 into each of the pressure chambers 33. Due to the expansion and contraction operations of the piezoelectric element 45, the diaphragm 43 is deformed, and the liquid in the pressure chamber 33 is pressurized and discharged from the nozzles 30.

FIG. 7 is a cross-sectional view of the liquid discharge head 20 taken along line B-B in FIG. 5. In other words, FIG. 7 is a cross-sectional view of the liquid discharge head 20 cut at a portion where the ventilation passage 21 is disposed.

As illustrated in FIG. 7, the ventilation passage 21 is disposed across both the nozzle plate 40 and the first channel plate 41. In this case, multiple through holes 40a and 40b defining the inlet ports 21a and the outlet ports 21b are formed in the nozzle plate 40, and longitudinal connection holes 41a (i.e., a connection channel) connecting the through holes 40a and the through holes 40b (the inlet ports 21a and the outlet ports 21b) of the nozzle plate 40 are formed in the first channel plate 41.

As described above, the ventilation passage 21 formed in multiple components including the nozzle plate 40 and the first channel plate 41 facilitates the formation of the ventilation passage 21 as compared with a case where the ventilation passage 21 is formed in a single component. If the ventilation passage 21 is formed in the single component, the single component is hollowed out to form the ventilation passage 21. On the other hand, when the ventilation passage 21 is formed in the multiple components, each of the multiple components is only punched out to form predetermined through holes (channel), and the multiple components are laminated one on another to easily form the ventilation passage 21.

FIG. 8 is a plan view of the nozzle plate 40, the first channel plate 41, and the second channel plate 42 superimposed one on another. In FIG. 8, the ventilation passages 21 (the connection holes 41a) and the pressure chambers 33 formed in the first channel plate 41 are indicated by the solid lines, and the nozzles 30, the inlet ports 21a (the through holes 40a), and the outlet ports 21b (the through holes 40b) formed in the nozzle plate 40, and the individual supply channels 34 formed in the second channel plate 42 are indicated by the dashed lines.

As illustrated in FIG. 8, the ventilation passage 21 (the connection hole 41a) formed in the first channel plate 41 passes between the pressure chambers 33 (and between the multiple nozzles 30) in the width direction. When the ventilation passage 21 passes between the pressure chambers 33 as in the present embodiment, there is a space for forming the ventilation passage 21 between the pressure chambers 33. In this case, it is difficult to narrow the interval (interval in the nozzle array direction) between the nozzles 30 of the nozzle array 32 and to arrange the nozzles 30 at high density. The space for the ventilation passage 21 hinders the liquid discharge head from being downsized in the nozzle array direction. In particular, as in the present embodiment, when the multiple inlet ports 21a and the multiple outlet ports 21b individually communicate with each other via the multiple ventilation passages 21 (the connection holes 41a) formed independently, the number of the ventilation passages 21 is the same as the number of the inlet ports 21a (or the outlet ports 21b). In other words, the multiple ventilation passages 21 are disposed between the multiple nozzles 30 and arranged (extended) along the moving direction. Such a configuration hinders high nozzle density and downsizing of the head.

In another embodiment of the present disclosure described below, a configuration for achieving high nozzle density and downsizing of the head is proposed. In the following description, differences from the above-described embodiment are focused, and redundant descriptions are simplified or omitted.

### Another Embodiment

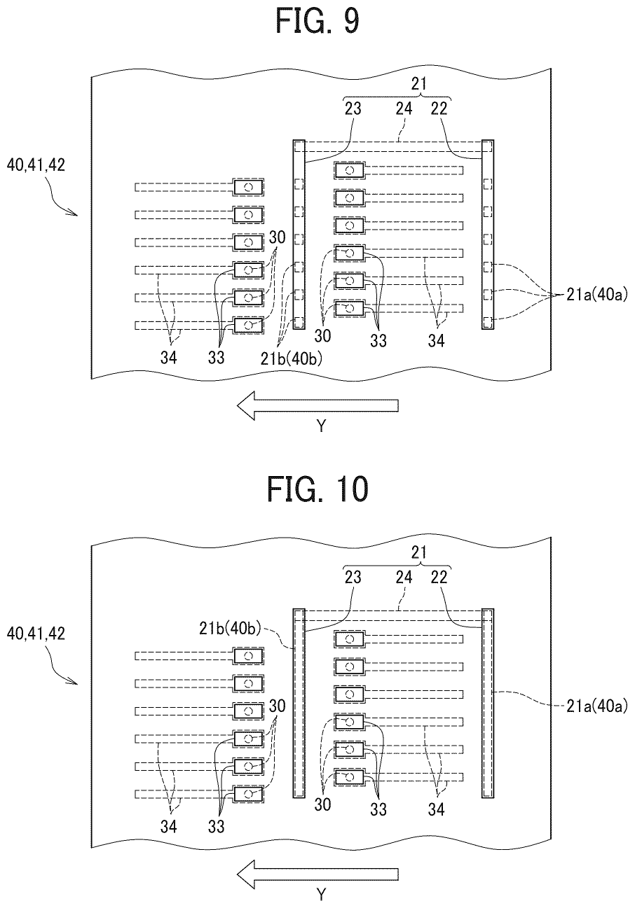

FIG. 9 is a plan view of the nozzle plate 40, the first channel plate 41, and the second channel plate 42 superimposed one on another. Also in FIG. 9, as in FIG. 8, the portions formed in the first channel plate 41 are indicated by the solid lines, and the portions formed in the nozzle plate 40 or the second channel plate 42 are indicated by the dashed lines.

As illustrated in FIG. 9, in the present embodiment, the multiple inlet ports 21a and the multiple outlet ports 21b communicate with each other via one common ventilation passage 21. In this case, the common ventilation passage 21 includes an inlet-side common passage 22 (inlet common passage) and an outlet-side common passage 23 (outlet common passage) formed in the first channel plate 41, and a connection common passage 24 formed in the second channel plate 42.

The inlet-side common passage 22 is a common ventilation passage communicating with all of the multiple inlet ports 21a, and extends in the nozzle array direction (top-and-bottom direction in FIG. 9) to overlap with each of the inlet ports 21a to connect the inlet ports 21a. The outlet-side common passage 23 is a common ventilation passage communicating with all of the multiple outlet ports 21b, and extends in the nozzle array direction (top-and-bottom direction in FIG. 9) to overlap with each of the outlet ports 21b to connect the outlet ports 21b. The connection common passage 24 extends in a direction (lateral direction in FIG. 9) orthogonal to or intersecting the nozzle array direction, and connects the inlet-side common passage 22 and the outlet-side common passage 23 to allow communication therebetween. The connection common passage 24 (i.e., the connection channel) is disposed at one end of the inlet-side common passage 22 in the width direction. In other words, the connection common passage 24 (i.e., the connection channel) is disposed outside, in the width direction, the multiple nozzles 30 arrayed in the width direction.

In the configuration as described above, when the upward airflow 9D (see FIG. 4) is generated during the ink discharge operation, the upward airflow 9D flows in from each of the inlet ports 21a and flows out from each of the outlet ports 21b through the common ventilation passage 21. Accordingly, also in this embodiment, similarly to the above-described embodiment, the airflow 9E (see FIG. 16) due to the upward airflow 9D colliding with the nozzle face 31 can be prevented from being generated, and thus the negative pressure is unlikely to be generated. As a result, the deviation of the landing position due to these influences can be effectively reduced.

In this embodiment, the multiple inlet ports 21a and the multiple outlet ports 21b communicate with each other via the common ventilation passage 21, and thus, the number of the ventilation passages 21 can be reduced as compared with the configuration in which the multiple inlet ports 21a and the multiple outlet ports 21b are individually connected via the multiple ventilation passages 21 as in the above-described embodiment. As a result, the space for forming the ventilation passages 21 is reduced, and thus, the head can be downsized. The common ventilation passage 21 is not limited to one integrated common channel, and may be divided into multiple channels as long as the number of the ventilation passages 21 can be reduced.

As illustrated in FIG. 9, in this embodiment, the common ventilation passages 21 (the inlet-side common passage 22, the outlet-side common passage 23, and the connection common passage 24) does not pass between the multiple pressure chambers 33 communicating with the multiple nozzles 30 forming the nozzle array 32 and does not pass between the multiple individual supply channels 34 communicating with the pressure chambers 33. In other words, the common ventilation passage 21 is disposed outside the multiple pressure chambers 33 and the multiple individual supply channels 34 and is not disposed between the multiple pressure chambers 33 and between the multiple individual supply channels 34. As described above, since the common ventilation passage 21 does not pass between the pressure chambers 33 and between the individual supply channels 34, the interval (interval in the nozzle array direction) between the nozzles 30 forming the nozzle array 32 can be narrowed. Accordingly, the high nozzle density and the downsizing of the head can be achieved.

As illustrated in FIG. 9, in this embodiment, among the inlet-side common passage 22, the outlet-side common passage 23, and the connection common passage 24 forming the common ventilation passage 21, the inlet-side common passage 22 and the outlet-side common passage 23 are formed in the first channel plate 41, and the connection common passage 24 is not formed in the first channel plate 41 but is formed in the second channel plate 42. As described above, the connection common passage 24 is formed in a component (the second channel plate 42) different from the component (the first channel plate 41) in which the inlet-side common passage 22 and the outlet-side common passage 23 are formed. Accordingly, a decrease in strength of the first channel plate 41 can be prevented to keep sufficient rigidity of the first channel plate 41 as compared with a configuration in which these common passages 22, 23, and 24 are collectively formed in the first channel plate 41. As a result, the liquid discharge head 20 is unlikely to be damaged. The inlet-side common passage 22, the outlet-side common passage 23, and the connection common passage 24 may be formed in one component as long as sufficient rigidity can be obtained.

### Still Another Embodiment

Still another embodiment of the present disclosure will be described below. FIG. 10 is a plan view of the nozzle plate 40, the first channel plate 41, and the second channel plate 42 superimposed one on another. Also in FIG. 10, as in FIGS. 8 and 9, the portions formed in the first channel plate 41 are indicated by the solid lines, and the portions formed in the nozzle plate 40 or the second channel plate 42 are indicated by the dashed lines.

As illustrated in FIG. 10, in this embodiment, the inlet port 21a and the outlet port 21b are not the multiple through holes 40a and 40b but one integrated through hole 40a and one integrated through hole 40b, respectively. In other words, the inlet port 21a and the outlet port 21b are elongated through holes 40a and 40b extending in the nozzle array direction (top-and-bottom direction in FIG. 10 and the width direction) over the multiple nozzles 30. Other configurations are the same as the configurations of the above-described embodiment.

As described above, the inlet port 21a and the outlet port 21b may be one integrated through hole 40a and one integrated through hole 40b, respectively. Also in this case, as in each of the above-described embodiments, the upward airflow 9D can flow in from the inlet port 21a and flow out from the outlet port 21b. Accordingly, the deviation of the landing position due to the influences of the upward airflow and the negative pressure can be effectively reduced.

Also in this embodiment, as in the above-described embodiment, the common ventilation passage 21 connecting the inlet port 21a and the outlet port 21b does not pass between the pressure chambers 33 communicating with the multiple nozzles 30 forming the nozzle array 32 and does not pass between the individual supply channels 34 communicating with the pressure chambers 33. Accordingly, the interval between the nozzles 30 can be narrowed, and the high nozzle density and the downsizing of the head can be achieved.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

In the above-described embodiments, the liquid discharge head is mounted on the line type head unit. However, an embodiment of the present disclosure is not limited to the line type head unit, and is also applicable to a so-called serial type head unit, in which the liquid discharge head discharges ink while moving in a main scanning direction (width direction). The serial type head unit will be described below.

### Configuration of Serial Type Head Unit

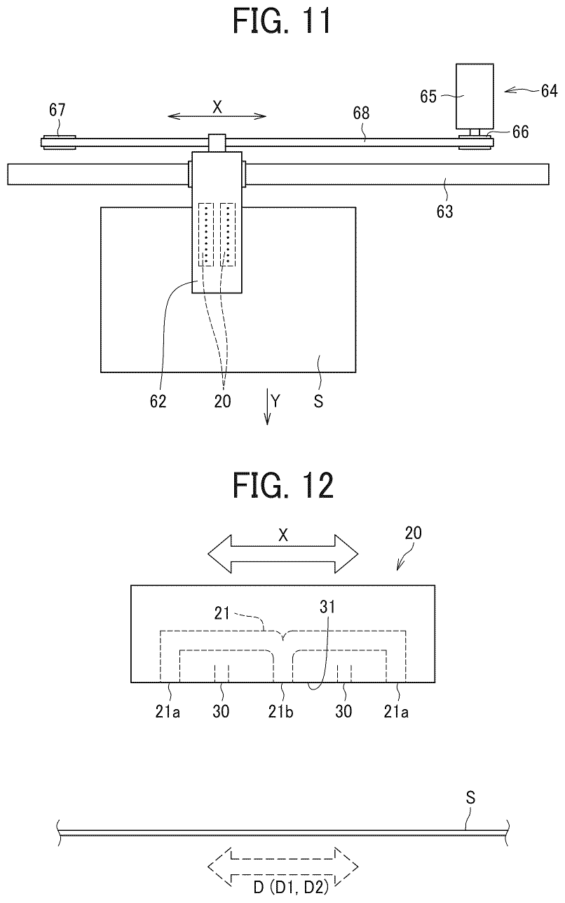

As illustrated in FIG. 11, the serial type head unit includes a carriage 62, a guide (guide rod) 63, and a drive device 64. The multiple liquid discharge heads 20 are mounted on the carriage 62. The guide 63 guides the carriage 62 in a main scanning direction X (may be referred to simply as a scanning direction) which is the width direction of the sheet S (direction orthogonal to the sheet conveyance direction Y). The drive device 64 moves the carriage 62.

The drive device 64 includes, for example, a motor 65 and a timing belt 68. The motor 65 serves as a driving source. The timing belt 68 is looped around a drive pulley 66 and a driven pulley 67. When the motor 65 is driven to rotate the drive pulley 66, the timing belt 68 rotates. As a result, the carriage 62 moves in the main scanning direction X along the guide 63. As the rotation direction of the motor 65 is switched between one direction and the opposite direction, the carriage 62 reciprocates in the main scanning direction X.

As illustrated in FIG. 11, when the sheet S is conveyed in the sheet conveyance direction Y and the sheet S reaches a predetermined image forming position, the conveyance of the sheet S is temporarily stopped. Then, liquid (ink) is discharged from the liquid discharge head 20 while the carriage 62 moves in the main scanning direction X. As a result, an image of a predetermined width is formed on the sheet S not in motion. Subsequently, the intermittent conveyance (conveyance and stop) of the sheet S in the sheet conveyance direction Y and the liquid discharge operation along with the reciprocating movement of the carriage 62 in the main scanning direction X are repeated to sequentially form the image on the sheet S.

At this time, since the sheet S and the liquid discharge head 20 move relative to each other, an airflow in the relative movement direction is generated between the sheet S and the liquid discharge head 20 due to the relative movement of the sheet S and the liquid discharge head 20. In other words, an airflow similar to the airflow 9C appears to be generated in a direction (i.e., the airflow direction) opposite to the scanning direction of the carriage 62 even when the sheet S does not move. Accordingly, in particular, on the upstream side of the nozzle located on the most upstream side in the relative movement direction of the sheet S with respect to the liquid discharge head 20, the airflow directed in the relative movement direction and the airflow directed in the direction opposite thereto collide with each other. As a result, the upward airflow directed toward the nozzle face is generated. Accordingly, in the serial type head unit, similarly to the line type head unit, the deviation of the landing position due to the upward airflow may be generated. The deviation of the landing position due to the influence of the negative pressure caused by the discharge of liquid may also be generated.

For this reason, preferably, the deviation of the landing position due to the influences of the upward airflow and the negative pressure is effectively reduced by applying the present disclosure also in the serial type head unit. In the serial type head unit, the head unit reciprocates in one direction and the direction opposite thereto, and thus, the positions on the upstream side and the downstream side in the relative movement direction are reversed according to the movement direction of the head unit.

Accordingly, as illustrated in FIG. 12, in the liquid discharge head 20 mounted on the serial type head unit, the inlet ports 21a are preferably disposed outside (on both outer sides of) the multiple nozzles 30 in relative movement directions D (the scanning direction of the carriage 62) of the sheet S relative to the liquid discharge head 20.

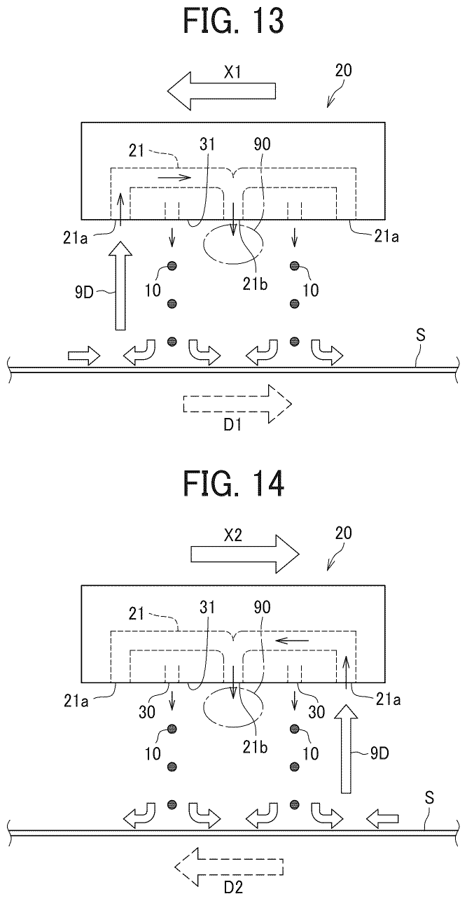

As a result, for example, as illustrated in FIG. 13, when the liquid discharge head 20 moves in one direction X1 in the main scanning direction, the upward airflow 9D flows in from the inlet port 21a (the inlet port 21a on the left side in FIG. 13) on the upstream side in a relative movement direction D1 of the sheet S, and the airflow can flow out from the outlet port 21b through the ventilation passage 21. As a result, similarly to the above-described embodiments, the airflow 9E (see FIG. 16) due to the upward airflow 9D colliding with the nozzle face 31 can be prevented from being generated, and thus the negative pressure is unlikely to be generated between the nozzles 30 (the portion 90 surrounded by the alternate long and short dash line in FIG. 13). As a result, the deviation of the landing position due to these influences can be effectively reduced.

As illustrated in FIG. 14, when the liquid discharge head 20 moves in a direction X2 opposite to the one direction X1, the sheet S appears to be moved in a relative movement direction D2 opposite to the relative movement direction D1. Accordingly, in this case, the upward airflow 9D flows in from the inlet port 21a (the inlet port 21a on the right side in FIG. 14) on the upstream side in the relative movement direction D2 of the sheet S, and the airflow can flow out from the outlet port 21b through the ventilation passage 21. As a result, the airflow 9E (see FIG. 16) due to the upward airflow 9D colliding with the nozzle face 31 can be prevented from being generated, and thus the negative pressure is unlikely to be generated between the nozzles 30 (the portion 90 surrounded by the alternate long and short dash line in FIG. 14). As a result, the deviation of the landing position due to these influences can be effectively reduced. In FIGS. 13 and 14, the ventilation passage 21 is disposed (extended) in the scanning direction parallel to the airflow direction.

As described above, by applying the present disclosure also to the liquid discharge head 20 mounted on the serial type head unit, the deviation of the landing position due to the influence of the upward airflow can be effectively reduced, as well as the deviation of the landing position due to the influence of the negative pressure to form a high-quality image. Since the deviation of the landing position can be effectively reduced simply by the ventilation passage 21, the landing accuracy can be enhanced with a simple configuration.

To achieve the high nozzle density and the downsizing of the head, in the liquid discharge head mounted on the serial type head unit, as in the above-described embodiments, the multiple inlet ports 21a and the multiple outlet ports 21b may communicate with each other via the common ventilation passage 21, and the common ventilation passage 21 may not pass between the pressure chambers 33 or between the individual supply channels 34.

The inlet port 21a is preferably disposed at least at a portion where the upward airflow 9D is likely to be generated in the serial type head unit. In other words, the inlet port 21a is preferably disposed at least upstream from the most upstream nozzle 30 in the relative movement direction of the sheet S. When the upward airflow is also generated at other portions, the inlet port 21a may be disposed at a portion other than the upstream side of the most upstream nozzle 30 (e.g., a portion on the downstream side where the upward airflow is generated).

The outlet port 21b is preferably disposed at least at a portion where a negative pressure is likely to be generated. Accordingly, the outlet port 21b is preferably arranged at least within the range which is on the downstream side of the most upstream nozzle 30 in the relative movement direction of the sheet S and on the upstream side of the most downstream nozzle 30 in the conveyance direction of the sheet S or the relative movement direction of the sheet S. In other words, the outlet port 21b is disposed downstream from the most upstream nozzle 30 in the relative movement direction of the sheet S and upstream from the most downstream nozzle 30 in the relative movement direction of the sheet S. The phrase “within the range” as used herein is not limited to a position between the most upstream nozzle 30 and the most downstream nozzle 30 (the position on the line segment connecting the most upstream nozzle 30 and the most downstream nozzle 30), and refers to within the range from the most upstream nozzle 30 to the most downstream nozzle 30 in the relative movement direction of the sheet S.

The liquid discharge head and the head unit described above can be applied not only to the image forming apparatus described above, but also to other liquid discharge apparatuses. When a liquid discharge apparatus discharges liquid onto a moving object (may be referred to simply as an object) that moves relative to the liquid discharge head, the deviation of the landing position may be generated. Accordingly, the deviation of the landing position can be effectively reduced by applying the present disclosure.

For example, the liquid discharge head and the head unit according to the present disclosure can also be applied to an electrode manufacturing apparatus for manufacturing an electrode by discharging a liquid composition. An electrode manufacturing apparatus to which the present disclosure can be applied will be described below.

### Configuration of Electrode Manufacturing Apparatus

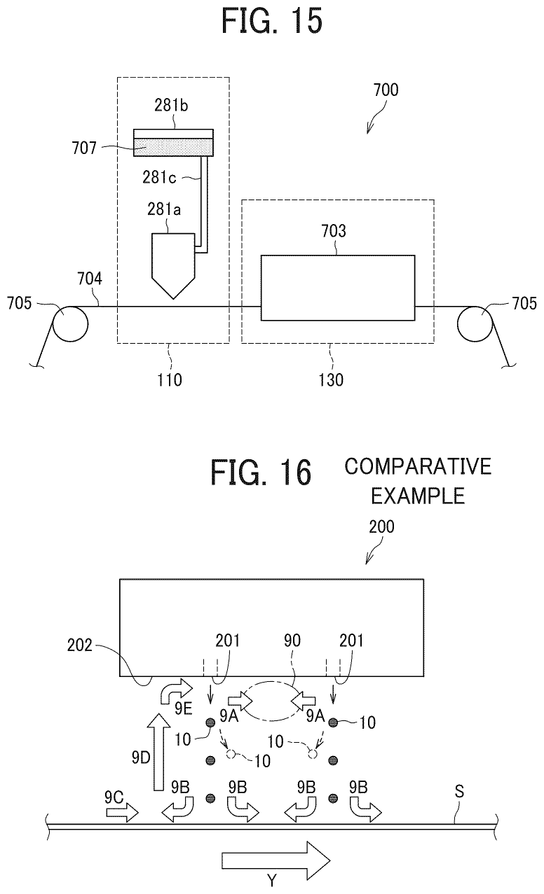

FIG. 15 is a diagram illustrating a schematic configuration of an electrode manufacturing apparatus 700. The electrode manufacturing apparatus 700 forms an electrode composite layer containing an active material on an electrode substrate (current collector). The electrode composite layer is used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

The electrode manufacturing apparatus 700 illustrated in FIG. 15 includes a discharge process device 110 and a heating process device 130. The discharge process device 110 performs a discharge process of applying a liquid composition for manufacturing an electrode onto a print base material 704 having a discharge target to form a liquid composition layer. The heating process device 130 performs a heating process of heating the liquid composition layer to obtain an electrode composite layer.

The electrode manufacturing apparatus 700 includes a conveyor 705 that conveys the print base material 704. The conveyor 705 conveys the print base material 704 to the discharge process device 110 and the heating process device 130 in this order at a preset speed. A method of producing the print base material 704 having the discharge target such as an active material layer is not limited to any particular method, and a known method can be appropriately selected. The discharge process device 110 includes a liquid discharge head 281a that performs an application process of applying the liquid composition onto the print base material 704, a storage container 281b that stores a liquid composition 707, and a supply tube 281c that supplies the liquid composition 707 stored in the storage container 281b to the liquid discharge head 281a.

The discharge process device 110 discharges the liquid composition 707 from the liquid discharge head 281a so that the liquid composition 707 is applied onto the print base material 704 to form a liquid composition layer in a thin film shape. The storage container 281b may be integrated with the electrode manufacturing apparatus 700 or may be detachable from the electrode manufacturing apparatus 700. The storage container 281b may be a container additionally attachable to a container integrated with the electrode manufacturing apparatus 700 or to a container detachable from the electrode manufacturing apparatus 700. The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heater 703 of the heating process device 130. Accordingly, the solvent is removed from the liquid composition layer. Thus, the electrode composite layer is formed. The heating process device 130 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector. A discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

By applying the present disclosure also to the electrode manufacturing apparatus 700 as described above, the deviation of the landing position of the liquid (liquid composition) can be effectively reduced, and the landing accuracy can be enhanced. Accordingly, the liquid composition can be discharged to a target place of the discharge target.

In addition, the present invention is widely applicable not only to the liquid discharge apparatus that discharges liquid onto a moving object such as a sheet or an electrode base that moves relative to the liquid discharge head, but also to a liquid discharge apparatus that discharges liquid onto an object (moving object) to which the liquid can at least temporarily adhere. Examples of the object (moving object) to which the liquid is discharged include resin film, wallpaper, and electronic substrate in addition to paper. Examples of the material of the object (moving object) to which the liquid is discharged include paper, leather, metal, plastic, glass, wood, and ceramics.

The liquid to be discharged by the liquid discharge apparatus is not limited to any particular liquid, and examples thereof include solutions, suspensions, and emulsions containing water, solvents such as organic solvents, colorants such as dyes and pigments, function-imparting materials such as polymerizable compounds, resins, and surfactants, biocompatible materials such as deoxyribonucleic acid (DNA), amino acids, proteins, and calcium, and edible materials such as natural pigments. Such a solution, a suspension, or an emulsion can be used for, e.g., inkjet ink, surface treatment liquid, a liquid for forming components of electronic element or light-emitting element, or forming a resist pattern of electronic circuit, or a three-dimensional fabrication material solution.

The above-described embodiments of the present disclosure include at least the following aspects.

### First Aspect

According to a first aspect, a liquid discharge head includes: multiple nozzles that discharge liquid to a moving object that moves relatively; and a nozzle face on which the multiple nozzles are open. The liquid discharge head includes a ventilation passage through which air passes, an inlet port through which air of the ventilation passage flows in, and an outlet port through which the air flows out. The inlet port and the outlet port are both disposed on the nozzle face.

In other words, a liquid discharge head includes a nozzle plate and a connection channel. The nozzle plate has a nozzle, an inlet port, and an outlet port. The nozzle is disposed on a nozzle face of the nozzle plate to discharge a liquid from the nozzle onto an object in a discharge direction. The inlet port is disposed on the nozzle face of the nozzle plate. The inlet port is disposed upstream from the nozzle in an airflow direction orthogonal to the discharge direction. The outlet port is disposed on the nozzle face of the nozzle plate. The outlet port is disposed downstream from the nozzle in the airflow direction. The connection channel connects the inlet port and the outlet port in the airflow direction to form a ventilation passage.

### Second Aspect

According to a second aspect, in the liquid discharge head of the first aspect, the inlet port is arranged on an outer side of the multiple nozzles in a relative movement direction of the moving object.

In other words, in the liquid discharge head according to the eleventh aspect, the inlet port is disposed outside the nozzle on the nozzle face in the scanning direction.

### Third Aspect

According to a third aspect, in the liquid discharge head of the first aspect or the second aspect, the inlet port is arranged at least on an upstream side of the nozzle which is located most upstream in a relative movement direction of the moving object.

In other words, the liquid discharge head according to the tenth aspect, further includes multiple nozzles including the nozzle. The multiple nozzles are arrayed in the moving direction. The inlet port is disposed upstream from the most upstream nozzle of the multiple nozzles in the moving direction.

### Fourth Aspect

According to a fourth aspect, in the liquid discharge head of any one of the first aspect to the third aspect, the outlet port is arranged at least within a range that is on a downstream side of the nozzle which is located most upstream in a relative movement direction of the moving object and on an upstream side of the nozzle which is located most downstream in the relative movement direction of the moving object.

In other words, in the liquid discharge head according to the third aspect, the outlet port is disposed downstream from the most upstream nozzle in the moving direction and upstream from the most downstream nozzle of the multiple nozzles in the moving direction.

### Fifth Aspect

According to a fifth aspect, in the liquid discharge head of any one of the first aspect to the fourth aspect, the inlet port includes multiple inlet ports, the outlet port includes multiple outlet ports, the ventilation passage includes multiple ventilation passages, and the multiple inlet ports and the multiple outlet ports individually communicate with each other through the multiple ventilation passages, each of which is independently provided.

In other words, the liquid discharge head according to the twelfth aspect, further includes multiple connection channels including the connection channel to form multiple ventilation passages including the ventilation passage. The nozzle plate further has multiple inlet ports including the inlet port and multiple outlet ports including the outlet port. The multiple inlet ports communicate with the multiple outlet ports through the multiple connection channels in the moving direction, respectively, to form the multiple ventilation passages.

### Sixth Aspect

According to a sixth aspect, in the liquid discharge head of any one of the first aspect to the fourth aspect, the inlet port includes multiple inlet ports, the outlet port includes multiple outlet ports, and the multiple inlet ports and the multiple outlet ports communicate with each other through the ventilation passage which is common.

In other words, the liquid discharge head according to the twelfth aspect, further includes an inlet common passage disposed in the width direction and an outlet common passage disposed in the width direction. The connection channel connects the inlet common passage and the outlet common passage in the moving direction to form the ventilation passage. The nozzle plate further has multiple inlet ports including the inlet port and multiple outlet ports including the outlet port. The inlet common passage connects each of the multiple inlet ports in the width direction. The outlet common passage connects each of the multiple outlet ports in the width direction. The connection channel is at one end of the inlet common passage in the width direction.

### Seventh Aspect

According to a seventh aspect, in the liquid discharge head of the sixth aspect, the ventilation passage which is common is arranged in a manner of not passing between pressure chambers communicating with the multiple nozzles forming a nozzle array and between individual supply channels communicating with the pressure chambers.

In other words, in the liquid discharge head according to the sixth aspect, the connection channel is disposed outside, in the width direction, the multiple nozzles arrayed in the width direction.

### Eighth Aspect

According to an eighth aspect, a head unit includes the liquid discharge head of any one of the first aspect to the seventh aspect. The liquid discharge head includes multiple liquid discharge heads.

In other words, a head unit includes multiple liquid discharge heads including the liquid discharge head according to any one of the first aspect to the seventh aspect.

### Ninth Aspect

According to a ninth aspect, a liquid discharge apparatus includes the liquid discharge head of any one of the first aspect to the seventh aspect or the head unit of the eighth aspect.

In other words, a liquid discharge apparatus includes the liquid discharge head according to the first aspect and a conveyor to convey the object to the liquid discharge head in a moving direction orthogonal to the discharge direction.

Alternatively, a liquid discharge apparatus includes the liquid discharge head according to the first aspect and a carriage mounting the liquid discharge head to move the liquid discharge head in a width direction parallel to the airflow direction and orthogonal to the discharge direction.

### Tenth Aspect

In the liquid discharge head according to the first aspect, the nozzle discharges the liquid from the nozzle onto the object moving in a moving direction orthogonal to the discharge direction. The ventilation passage is disposed in the moving direction along the airflow direction.

### Eleventh Aspect

In the liquid discharge head according to the first aspect, the nozzle discharges the liquid from the nozzle onto the object while moving in a scanning direction orthogonal to the discharge direction. The ventilation passage is disposed in the scanning direction parallel to the airflow direction.

### Twelfth Aspect

In the liquid discharge head according to the fourth aspect, the multiple nozzles are arrayed in a width direction orthogonal to each of the moving direction and the discharge direction. The ventilation passage is disposed between the multiple nozzles in the width direction and arranged along the moving direction.

### Thirteenth Aspect

The liquid discharge head according to the first aspect, further includes a first channel plate on the nozzle plate and a second channel plate on the first channel plate. The connection channel is formed in the first channel plate between the nozzle plate and the second channel plate.

### Fourteenth Aspect

In the liquid discharge head according to the fourth aspect, the multiple nozzles are arrayed in a width direction orthogonal to each of the moving direction and the discharge direction. The inlet port extends in the width direction over the multiple nozzles. The outlet port extends in the width direction over the multiple nozzles. The connection channel connects the inlet port and the outlet port in the moving direction to form the ventilation passage. The connection channel is at one end of the inlet port in the width direction.

As described above, according to one aspect of the present disclosure, deviation of the landing position of liquid can be effectively reduced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having:
a nozzle on a nozzle face of the nozzle plate, the nozzle to discharge a liquid from the nozzle onto an object in a discharge direction;
an inlet port on the nozzle face of the nozzle plate, the inlet port disposed upstream from the nozzle in an airflow direction orthogonal to the discharge direction; and
an outlet port on the nozzle face of the nozzle plate, the outlet port disposed downstream from the nozzle in the airflow direction; and
a connection channel connecting the inlet port and the outlet port in the airflow direction to form a ventilation passage.

2. The liquid discharge head according to claim 1,
wherein the nozzle discharges the liquid from the nozzle onto the object moving in a moving direction orthogonal to the discharge direction, and
the ventilation passage is disposed in the moving direction along the airflow direction.

3. The liquid discharge head according to claim 1,
wherein the nozzle discharges the liquid from the nozzle onto the object while moving in a scanning direction orthogonal to the discharge direction, and
the ventilation passage is disposed in the scanning direction parallel to the airflow direction.

4. The liquid discharge head according to claim 3,
wherein the inlet port is disposed outside the nozzle on the nozzle face in the scanning direction.

5. The liquid discharge head according to claim 2, further comprising multiple nozzles including the nozzle, the multiple nozzles arrayed in the moving direction,
wherein the inlet port is disposed upstream from the most upstream nozzle of the multiple nozzles in the moving direction.

6. The liquid discharge head according to claim 5,
wherein the outlet port is disposed:
downstream from the most upstream nozzle in the moving direction; and
upstream from the most downstream nozzle of the multiple nozzles in the moving direction.

7. The liquid discharge head according to claim 6,
wherein the multiple nozzles are arrayed in a width direction orthogonal to each of the moving direction and the discharge direction,
the ventilation passage is:
disposed between the multiple nozzles in the width direction; and
arranged along the moving direction.

8. The liquid discharge head according to claim 7, further comprising multiple connection channels including the connection channel to form multiple ventilation passages including the ventilation passage,
wherein the nozzle plate further has:
multiple inlet ports including the inlet port; and
multiple outlet ports including the outlet port,
the multiple inlet ports communicate with the multiple outlet ports through the multiple connection channels in the moving direction, respectively, to form the multiple ventilation passages.

9. The liquid discharge head according to claim 7, further comprising:
an inlet common passage disposed in the width direction; and
an outlet common passage disposed in the width direction,
the connection channel connecting the inlet common passage and the outlet common passage in the moving direction to form the ventilation passage,
wherein the nozzle plate further has:
multiple inlet ports including the inlet port; and
multiple outlet ports including the outlet port,
the inlet common passage connects each of the multiple inlet ports in the width direction,
the outlet common passage connects each of the multiple outlet ports in the width direction, and
the connection channel is at one end of the inlet common passage in the width direction.

10. The liquid discharge head according to claim 9,
wherein the connection channel is disposed outside, in the width direction, the multiple nozzles arrayed in the width direction.

11. The liquid discharge head according to claim 1, further comprising:
a first channel plate on the nozzle plate; and
a second channel plate on the first channel plate,
wherein the connection channel is formed in the first channel plate between the nozzle plate and the second channel plate.

12. A head unit comprising multiple liquid discharge heads including the liquid discharge head according to claim 1.

13. A liquid discharge apparatus comprising:
the liquid discharge head according to claim 1; and
a conveyor to convey the object to the liquid discharge head in a moving direction orthogonal to the discharge direction.

14. A liquid discharge apparatus comprising:
the liquid discharge head according to claim 1; and
a carriage mounting the liquid discharge head to move the liquid discharge head in a width direction parallel to the airflow direction and orthogonal to the discharge direction.

15. The liquid discharge head according to claim 6,
wherein the multiple nozzles are arrayed in a width direction orthogonal to each of the moving direction and the discharge direction,
the inlet port extends in the width direction over the multiple nozzles,
the outlet port extends in the width direction over the multiple nozzles,
the connection channel connects the inlet port and the outlet port in the moving direction to form the ventilation passage, and
the connection channel is at one end of the inlet port in the width direction.
